(19) United States
(12) Patent Application Publication
(10) Pub. No.: US 2010/0169024 A1
(43) Pub. Date: Jul. 1, 2010

(54) DEFINING QUANTITATIVE SIGNATURES FOR DIFFERENT GLEASON GRADES OF PROSTATE CANCER USING MAGNETIC RESONANCE SPECTROSCOPY

(75) Inventors: Anant Madabhushi, South Plainfield, NJ (US); Pallavi Tiwari, Highland Park, NJ (US); Mark Rosen, Bala Cynwyd, PA (US)

Correspondence Address: RATNERPRESTIA, P.O. BOX 980, VALLEY FORGE, PA, 19482, US

(73) Assignees: The Trustees of the University of Pennsylvania, Philadelphia, PA (US); Rutgers, The State University of New Jersey, New Brunswick, NJ (US)

(21) Appl. No.: 12/555,556

(22) Filed: Sep. 8, 2009

Related U.S. Application Data
(63) Continuation-in-part of application No. PCT/US2008/081656, filed on Oct. 29, 2008.
(60) Provisional application No. 60/983,553, filed on Oct. 29, 2007.

(51) Int. Cl. G06F 19/00

(52) U.S. Cl. 702/19

(57) ABSTRACT

A method for classifying a possible cancer from a magnetic resonance spectrographic (MRS) dataset includes extracting at least one feature from the MRS dataset as being identified with the possible cancer and embedding the extracted feature into a low dimensional space to form an embedded space. The method then clusters the embedded space into clusters representing a plurality of predetermined classes and spectrally decomposing the clusters to identify substantially significant independent metabolic signatures. The method then classifies the possible cancer as belong to one of at least two cancer classes based on the identified independent metabolic signatures.

This application is a CIP of PCT application no. PCT/US2008/081656 filed on Oct. 29, 2008, the contents of which are incorporated herein by reference. This application also claims benefit of U.S. provisional application Nos. 60/983,553 and

### BACKGROUND OF THE INVENTION

Prostatic adenocarcinoma (CaP) is the most common malignancy of men with approximately 192,280 new cases and 27,360 deaths estimated to occur in 2009 (American Cancer Society). Currently, screening of CaP is based on trans-rectal ultrasound (TRUS) biopsy, which is shown to have low detection accuracy (˜25%) owing to the low resolution of ultrasound. Although less aggressive CaP cases are not life threatening and could be classified as “wait and watch” candidates, aggressive treatment is essential for patients with aggressive CaP for improved survival rate. Hence, there is an urgent need of a computerized decision support (CDS) system which could assist in biopsy by providing a probabilistic map of areas corresponding to biologically significant CaP for early diagnosis and improved patient survival and outcome.

### Biologically Aggressive Prostate Cancer and Relationship to Gleason Grade

The Gleason grade system is the most commonly used system in USA for diagnosis of “aggressivity” of CaP. Standard grading system designed by Gleason et al. separated architectural features of CaP into 1 of 5 histological patterns of decreasing differentiation, pattern 1 being most differentiated (resembling benign cells) and Gleason pattern 5 being least differentiated (FIG. 2). Sum of primary and secondary grades of CaP identified in the tissue, is known as Gleason score, where high Gleason score corresponds to worse prognoses. High Gleason score (>6) tends to be correlated with more biologically aggressive disease and worse prognoses for long-term, metastasis-free survival. Hence, it is crucial to detect high Gleason grade on the prostate for early diagnosis and treatment of biologically aggressive disease.

### Role of Magnetic Resonance Spectroscopy in Detecting Prostate Cancer

Over the last decade, Magnetic Resonance Spectroscopic Imaging (MRSI) has emerged as a useful complement to structural MR imaging for potential screening of CaP. MRSI is a non-invasive technique used to obtain the metabolic concentrations of specific molecular markers and biochemicals in the prostate including citrate, creatine and choline, changes in concentration of which have been shown to be linked to presence of CaP. The relative concentrations of choline, creatine, and citrate (CC/C) are obtained by calculating the area under the peak for these metabolites to assess presence of CaP at a specific prostate location on the T2-w MRI. Recently, MR spectroscopic signatures correlating to different grades of CaP have been identified. It has been qualitatively demonstrated in clinical studies that high Gleason grade is associated with elevated ratios of CC/C.

### SUMMARY OF THE INVENTION

An embodiment of the present invention includes an ICA based classifier capable of automatically distinguishing different grades of CaP based on the metabolic signatures obtained via MR spectroscopy in order to identify biologically significant high grade CaP (Gleason score >6) for early diagnosis and treatment.

### BRIEF DESCRIPTION OF THE DRAWINGS

FIG. 1a is an MRI slice of a prostate having a superimposed 3×7 voxel grid;

FIGS. 1b-1e are spectra corresponding to the 3×7 voxel grid shown in FIG. 1a;

FIG. 2 is a drawing useful for describing different Gleason Grades;

FIG. 3 are histography sections useful for describing the example embodiments;

FIG. 4 is a flowchart useful for describing the example embodiments;

FIGS. 5a, 5b and 5c are spectral grids that are useful for describing the example embodiments;

FIG. 6 is a graph showing quantatative evaluation results that is useful for describing the example embodiments;

FIG. 7 is a set of graphs that are useful for describing the example embodiments;

FIGS. 8a, 8b, 8c and 8d are MRS images that are useful for describing the example embodiments;

FIGS. 8e, 8f and 8g are graphs that are useful for describing the example embodiments;

FIGS. 9a, 9b and 9c are spectral grids that are useful for describing the example embodiments;

FIGS. 9d, 9e and 9f are graphs that are useful for describing the example embodiments;

FIG. 10 is an MRI slice and graphs showing clusters that are useful for describing the example embodiments.

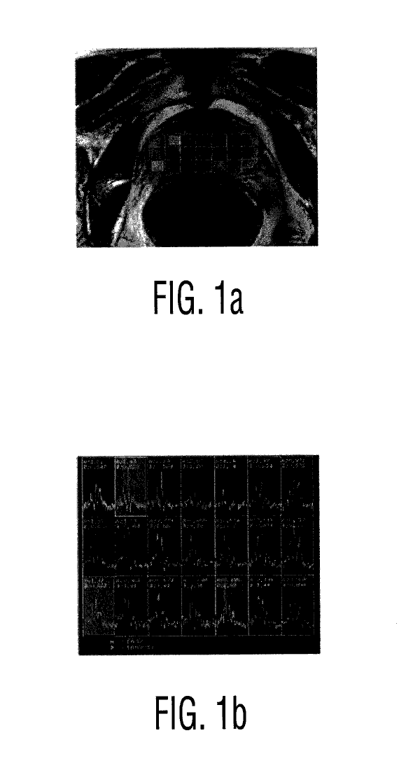

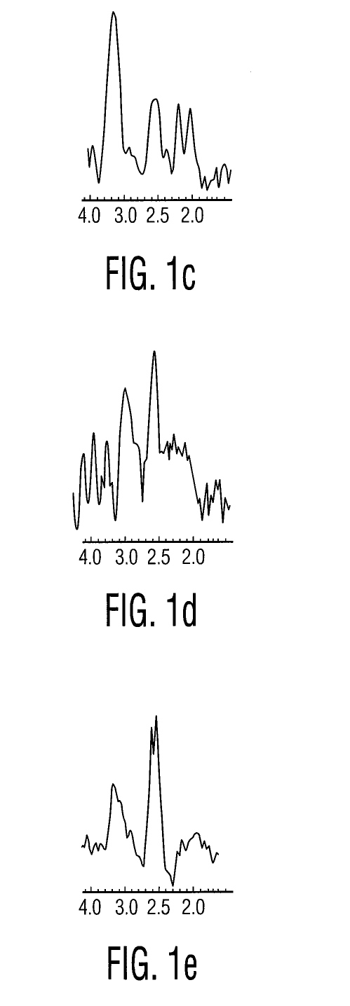

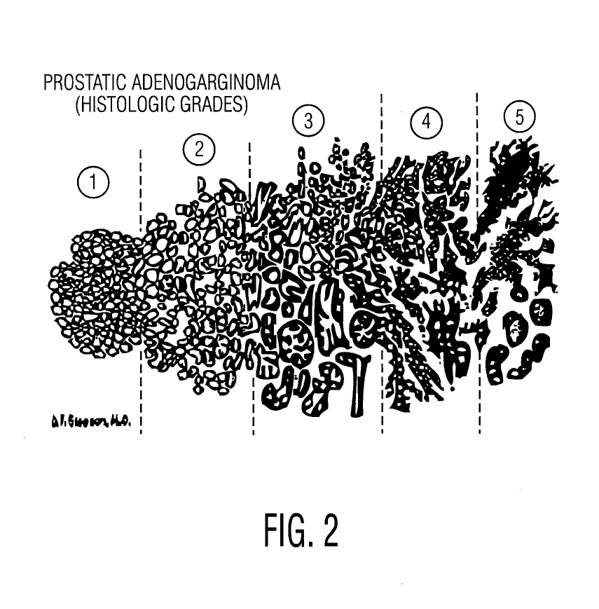

### DETAILED DESCRIPTION OF THE INVENTION

With increasing detection of early CaP with improved diagnostic methodologies (e.g. multi-protocol high resolution MRI/MRS), it has become important to predict biologic behaviors and “aggressivity” to identify patients who might benefit from a “wait and watch policy” as opposed to those patients who might be better suited to application of more aggressive strategies. In other words, clinically applicable prognostic markers are urgently needed to assist in the selection of optimal therapy. The inventors have been working on sophisticated machine learning algorithms to identify CaP on the prostate using MRS. With intent to find biological relevant CaP, in the current invention, the primary focus is on differentiating MRS signatures for different grades (low vs. high) of cancer. Improved algorithms have been developed such as consensus-locally linear embedding (C-LLE) and replicated clustering for unsupervised detection of CaP followed by Independent component analysis (ICA) to accurately identify and separate biologically relevant CaP by validating unsupervised clustering results. One example embodiment, described below, deals with developing such an integrated detection and grading computerized decision support scheme that can find biologically relevant aggressive (high grade) prostate cancer using MRS for early prognosis.

The inventors have identified the following problems and solutions:

Problem I: Locally linear embedding is a non-linear dimensionality reduction method used for data analysis and visualization of high dimensional non-linear biomedical data. However, it is dependent on a user defined parameter, K, value of which is non-obvious in an unsupervised context. Different low dimensional embeddings obtained for different values of κ are unstable and uncorrelated.

Solution I: According to one embodiment, a C-LLE scheme is proposed which combines multiple embeddings and provides a stable embedding solution from across multiple data projections for improved classification of the MRS data based on the spectral similarity. This scheme is not limited for this specific purpose but could be used to provide a stable low dimensional embedding of any high dimensional non-linear data.

Problem II: Ideally, unsupervised classification techniques are being developed by the inventors to automatically identify suspicious regions using Magnetic Resonance spectroscopy, which involves cancer detection on the gland without any prior knowledge. However, in the absence of any expert annotated ground truth, there is no way to validate the accuracy of cancer detection when employing unsupervised schemes. Even if cancer cluster is determined with confidence, the other important issue is to automatically determine the grade of cancer.

Solution II: ICA is a spectral decomposition technique used to decompose the signals into statistically independent components. First consensus embedding (C-LLE) and clustering are performed to identify various classes on the prostate and cancer class is identified by comparison with the defined ground truth. ICA, when performed on each of the different clusters obtained from the classifier, would then be able to parse out the specific signatures defining the cluster of similar spectra. The inventors have employed ICA to validate the efficacy of the unsupervised cancer detection algorithms for CDS by obtaining a representative independent component from each tissue class obtained from the classification and comparing it with a typical cancer/benign spectra. The example method is unique in a way that it not only identifies the suspicious regions on the prostate in a completely unsupervised fashion, but also validates the results using the prior information of the specific signatures of the spectra.

The objective behind LLE is to non-linearly map objects c, dεC that are adjacent in the M dimensional ambient space (F(c), F(d)) to adjacent locations in the low dimensional embedding (S(c), S(d)), where (S(c), S(d)) represent the m-dimensional dominant eigen vectors corresponding to c, d (m<<M). If d is in the κ neighborhood of cεC, then c, dεC are assumed to be linearly related. LLE attempts to non-linearly project each F(c) to S(c) so that the κ neighborhood of cεC is preserved. LLE is sensitive to the choice of K since different values of κ will result in different low dimensional data representations.

### Algorithm for C-LLE

Step 1: Multiple lower dimensional embeddings are generated by varying κε{1, . . . K} using LLE. Each embedding Sκ(c) will hence represent adjacencies between objects cᵢ, cⱼεC, i, jε{1, . . . |C|}, where |C| is the cardinality of C. Thus ∥Sκ(ci)−Sκ(cj)∥ψ will vary as a function of κ.

Step 2: Obtain MLE of pairwise object adjacency: A confusion matrix Wκε [symbol] ^{|C|×|C|} representing the adjacency between any two objects cᵢ, cⱼεC, i, j ε{1, . . . , |C|} in the lower dimensional embedding representation Sκ(c) is calculated as:

W_{κ}(i,j)= [symbol] _{κ}(cᵢ,cⱼ)=∥S_{κ}(cᵢ)−S_{κ}(cⱼ)∥_{ψ};

where cᵢ, cⱼεC, for i, jε{1, . . . , |C|}, κε{1, . . . , K}, and ψ in this case is the L2 norm. MLE of Dκ(cᵢ, cⱼ) is estimated as the mode of all adjacency values in W_{κ}(i, j) over all κ. This \hat{D} for all cεC is then used to obtain the new confusion matrix Ŵ.

Step 3: Multidimensional scaling (MDS): MDS is applied to Ŵ to achieve the final combined embedding S(c) for cεC. MDS is implemented as a linear method that preserves the Euclidean geometry between each pair of objects cᵢ, cεC, i, jε{1, . . . , |C|}. This is done by finding optimal positions for the data points cᵢ, cⱼ in lower-dimensional space through minimization of the least squares error in the input pair-wise distances in Ŵ.

### Application of C-LLE to Cap Detection for Prostate Cancer Detection

The ICA based CDS system for detecting prostate cancer using Magnetic Resonance Spectroscopy (MRS) may be applied to prostate cancer detection as described below.

### Data Description

A total of 18 1.5 T in vivo endorectal T2-weighted MRI and MRS ACRIN studies were obtained prior to prostatectomy. Partial ground truth for the CaP extent on MR studies is available in the form of approximate sextant locations and sizes for each study. The maximum diameter of the tumor is also recorded in each of the 6 prostate sextants (left base, left midgland, left apex, right base, right midgland, right apex). The tumor size and sextant locations were used to identify a potential cancer space used for performing a semi-quantitative evaluation of the CDS scheme.

### Algorithm Overview

Step 1: Establish Tumor Ground Truth on In Vivo MR from Histology

In the first step an automated segmentation scheme (MANTRA, WERITAS) that automatically isolates the prostate region on in vivo endorectal MR imagery. Following prostate segmentation the area corresponding to CaP are identified on the MRI via image registration from corresponding histology. This establishes the ground truth extent of CaP on MRI for CDS model building and evaluation.

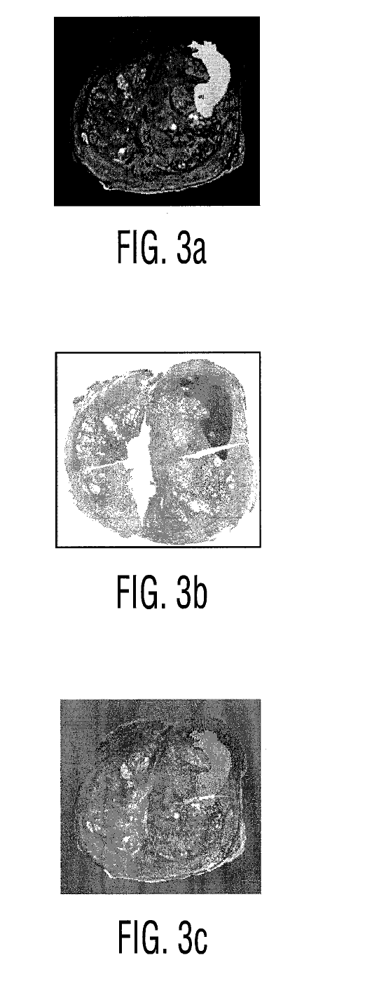

A multi-modal registration scheme called COFEMI (Combined Feature Ensemble based Mutual Information) is applied to non-linearly registering prostate whole mount histological sections (WMHS) on which CaP extent has been manually identified by H&E staining (FIG. 3(a)) and MRI sections (FIG. 3(b)). FIG. 3(c) shows the registration of MRI and WMHS with the CaP extent from WMHS mapped (in green) onto the corresponding MRI slice.

Step 2: Dimensionality Reduction of MR spectra using Consensus Locally Linear Embedding

Many biomedical applications use linear dimensionality reduction (DR) schemes such as Principal Component Analysis (PCA) for data analysis and visualization. However, due to inherent non-linearities in biomedical data, non-linear dimensionality reduction (NLDR) schemes have begun to be employed to non-linearly embed multi-dimensional data in a lower dimensional space. Locally Linear Embedding (LLE), a NLDR scheme attempts to preserve geodesic distances between objects from the high to the low dimensional spaces unlike PCA which preserves Euclidean distances. LLE attempts to capture geodesic distance between objects by first assuming that neighboring objects are linearly related. Thus, the low dimensional data representations are a function of κ, the LLE parameter controlling the size of the local neighborhood within which linearity is assumed. Since LLE is typically used in an unsupervised context, a priori the optimal value of κ or data representation is non-obvious owing to the arbitrary density of the dataset.

An example consensus-LLE (C-LLE) algorithm has been developed, wherein multiple individual data representations obtained via LLE by varying κ are combined to obtain a stable embedding representation. The hypothesis is that the multiple low dimensional data embeddings obtained by varying κ are unstable and uncorrelated. In order to obtain the true class relationship between objects, mode of pairwise object adjacencies is calculated across the multiple low dimensional data embeddings. Multi-dimensional Scaling, a linear DR scheme, is then applied to the matrix of modal object adjacencies to obtain the final stable low dimensional data embedding. C-LLE is used to reduce each high dimensional spectra g(c) to a low dimensional Eigen space, S(c).

Step 3: Classification of MR Spectra as Cancer and Non-Cancer Based on the Extracted Feature Values

Consensus clustering has been employed to overcome the instability associated with centroid based clustering algorithms such as κ-means clustering. Multiple weak clusterings V¹ₜ, V², V³ₜ, tε{0, . . . , T}, are developed by repeated application of κ-means clustering on the combined low dimensional manifold S(c), for all cεC. Each cluster, Vₜ is a set of objects which has been assigned the same class label by the κ-means clustering algorithm. As the number of elements in each cluster tends to change for each such iteration of κ-means, a co-association matrix H is calculated with the underlying assumption that voxels belonging to a natural cluster are very likely to be co-located in the same cluster for each iteration. Co-occurrences of pairs of voxels cᵢ, cⱼεC in the same cluster Vₜ are hence taken as votes for their association. H(i, j) thus represents the number of times cᵢ, cⱼεC were found in the same cluster over T iterations. Multi-dimensional scaling (MDS), a data projection scheme will then be applied to H followed by a final unsupervised classification using κ-means, to obtain final stable clusters V₁, V₂, V₃.

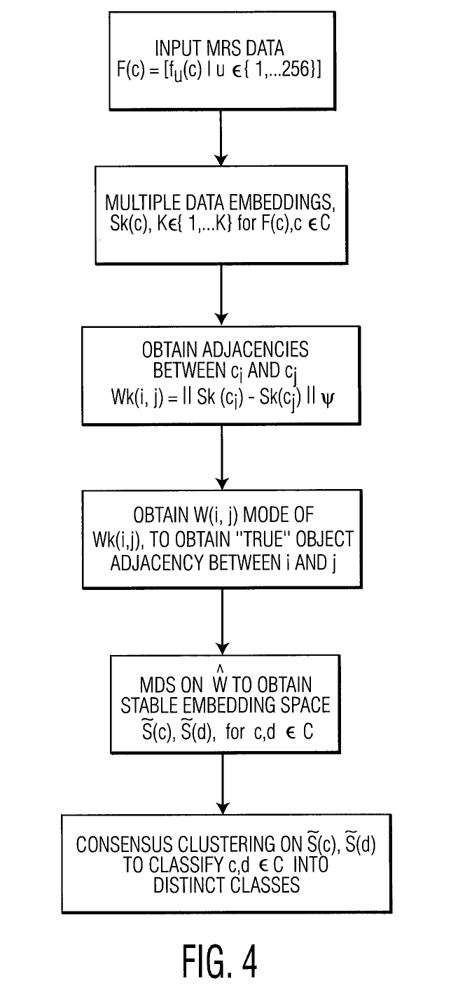

FIG. 4 shows the flowchart demonstrating the different steps comprising the prostate MRS detection scheme.

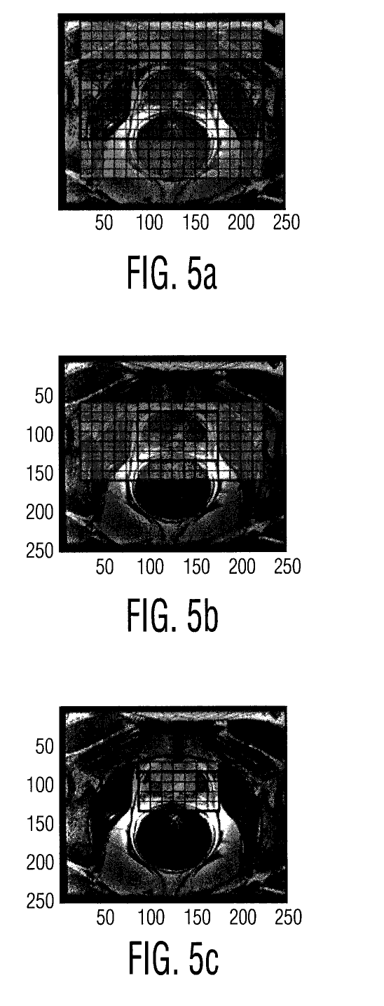

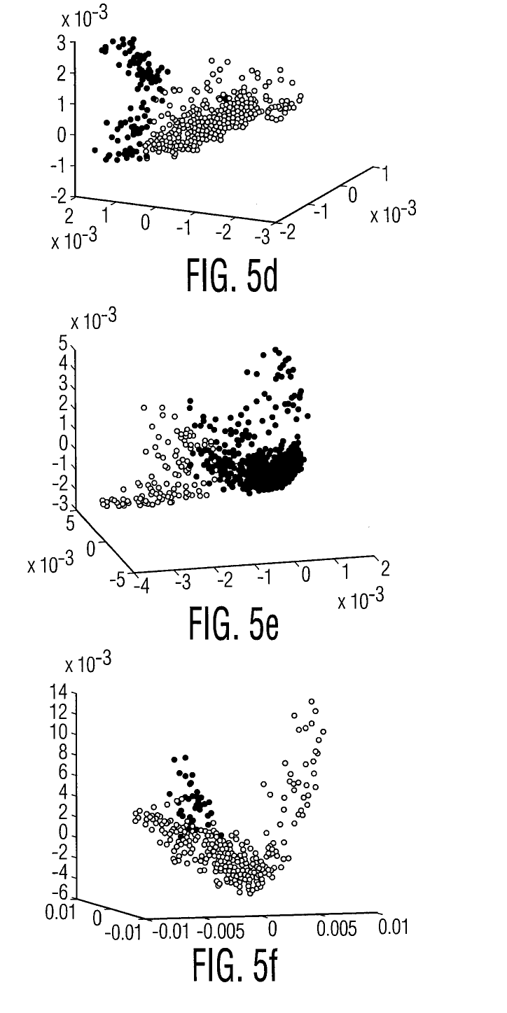

An example CDS system for detection of prostate cancer uses 1.5 T Magnetic Resonance Spectroscopy using hierarchical clustering and improved classification schemes to automatically and accurately identify suspicious regions on the prostate. FIG. 5 shows the qualitative results of the hierarchical cascade scheme for distinguishing prostatic from extra-capsular spectra. FIG. 5(a) represents spatial maps of the spectral grid \tilde{C}₀ (16×16 spectral voxels) superimposed on the corresponding T2-w MRI scene for one patient study. Every cε\tilde{C}₀ in FIG. 5(a) is assigned one of two colors (blue (darker dots) and red (lighter dots)), corresponding to spectra identified by the algorithm as prostatic or extra-capsular. Note that the dominant cluster (spatial locations in red in FIG. 5(a)) has been eliminated in the second iteration (\tilde{C}₁ (16×8 spectral voxels)) (FIG. 5(b)). The final spectral grid (\tilde{C}₂ in FIG. 5(c)) is obtained after elimination of extra-capsular spectra (red locations) during the third iteration of the cascade. FIG. 5(d)-(f) represent the embedding plots (where each original spectral vector F(c), cεC is plotted in 3D Eigen vector space using the 3 dominant embedding values as co-ordinates) from \tilde{C}₀ (16×16 spectral voxels) (d) to \tilde{C}₂ (7×4 spectral voxels) (f) for one study at 3 different levels of the cascade. Note that at the end of the third iteration, the prostate ROI has been accurately identified and the spectral grid accurately overlaid on the prostate. Further note that in FIGS. 5(a)-(c), the spectral grid with the pronounced boundary indicates the ROI during the current iteration.

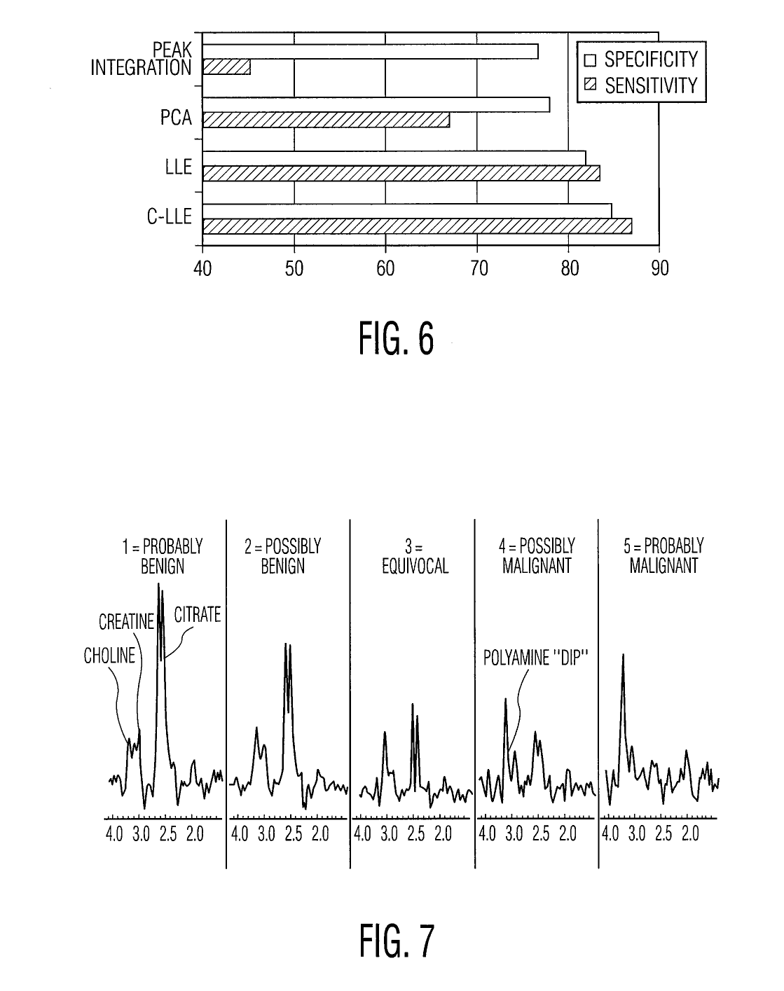

FIG. 6 shows the quantitative evaluation of the MRS CDS scheme (C-LLE) with the other traditional automated methods for MRS classification. Note that the CDS scheme significantly outperforms the other state of art methods like peak detection and PCA. The sensitivity and specificity are close to 87% for C-LLE while other methods perform poorly.

### ICA Based CDS for Grading Cap

Step 1. Identifying independent components from cancer clusters: Independent Component Analysis (ICA) is a multivariate decomposition technique which linearly transforms the observed data into statistically maximally independent components (ICs). If it is assumed that MRS is characterized as a mixture of resonances from different metabolites with principal contributions from choline, creatine and citrate, given as F(c)=a(1)s(1)+a(2)s(2)+a(3)s(3), ICA could be used to obtain the independent components, s(i), iε{1, 2, 3} which contribute the most in the spectra. s(1), s(2), s(3) are obtained from each F(c), cεC, which in the context of prostate MRS, should represent the individual spectral contributions from choline, creatine and citrate.

Step 2. Matching Independent Components from Clusters against 5-point model signatures: The 5 point scale identifies MR spectra into 5 categories corresponding to (1) benign, (2) possibly benign, (3) equivocal, (4) possibly cancerous, and (5) cancerous classes. Model signatures (ψ(1), ψ(2), ψ(3), ψ(4), ψ(5)) are defined for these 5 classes as shown in FIG. 7. Following extraction of V1, V2, . . . , Vn, the 3 principal ICs for each of the clusters sⱼ(1), sⱼ (2), sⱼ (3), for jε{1, . . . , n} are obtained. The objective is to identify the closest match between the ICs sⱼ(1), sⱼ (2), sⱼ (3) corresponding to cluster j and ψ(1), ψ(2), ψ(3), ψ(4), ψ(5). A number of different similarity measures are used for comparing similarity between sⱼ(1), sⱼ (2), sⱼ (3) and ψ(1), ψ(2), ψ(3), ψ(4), ψ(5), including (a) mutual information, (b) entropy, and (c) correlation. Based on the consensus of the different similarity measures each of the clusters V₁, V₂, . . . , Vₙ are identified as belonging to 1 of the 5 classes on the 5-point scale. Each of the voxels in each cluster are consequently assigned 1 to 5.

Step 3. Matching Independent Components from clusters against Gleason grade signatures: Once the cancer class is accurately identified, the next step is to identify the Gleason grade within the cancer location. C-LLE and unsupervised clustering are performed again in the region identified as CaP by the classifier and a similar approach as mention in Step 2 above is adopted to identify the grade by comparing the independent components from each cluster within the cancer cluster with a typical Gleason signature.

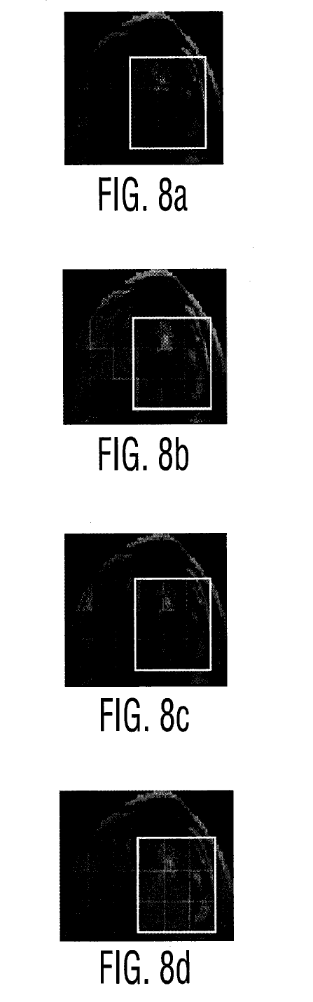

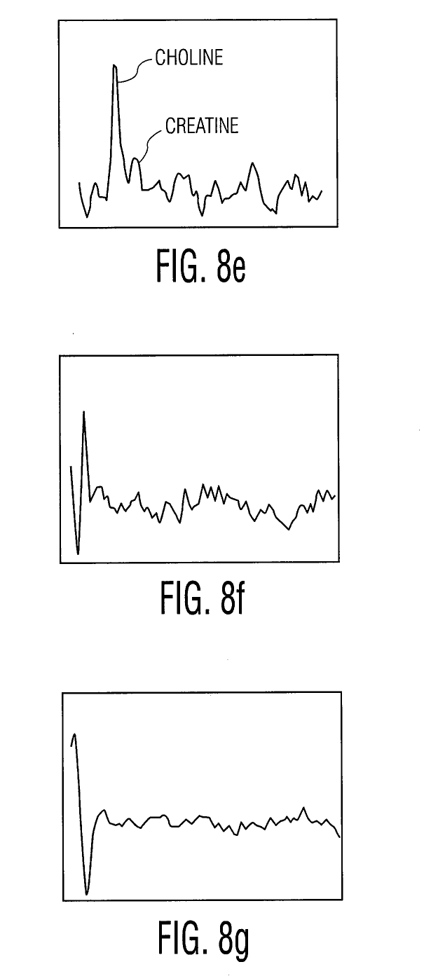

FIG. 8 demonstrates qualitative CaP detection results obtained by the example CDS algorithm compared with other methods which are traditionally used such as peak detection, z-score and other classification techniques like Principal component analysis (PCA). The white box superposed on 8(a)-(d) shows the potential cancer space for corresponding slices. In each of FIGS. 8(a)-(d) the red cluster was determined as cancer by each of the method. Note that FIG. 8(d), which is the result obtained from the example CDS scheme, shows excellent sensitivity and specificity. FIGS. 8(a)-(c) shows the results obtained from peak detection, z-score method and PCA which suggest very low sensitivity and specificity compared to CDS (FIG. 8(d)). To assess the validity of the example CDS scheme with traditionally used PCA, the inventors isolated independent components (IC) performing independent component analysis (ICA) from clusters identified as CaP on both the schemes. FIG. 8(e) shows a spectrum identified as cancerous according to the 5-point model defined by Kurhanewicz et al. in an article entitled, “Prostate Depiction at Endorectal MR Spectroscopic Imaging: Investigation of a Standardized Evaluation System”, Genitourinary Imaging” Radiology vol. 233, pp. 701-708, December 2004. FIG. 8(f) shows an IC obtained from the cluster identified as CaP by CDS algorithm (shown as red in (d)), in 8(g) is shown corresponding IC obtained via traditionally used algorithm, PCA. Note the strong correlation between the spectra shown in 6(e) and 6(f) compared to that in 8(g) which suggests the efficacy of the example CDS scheme in identifying CaP.

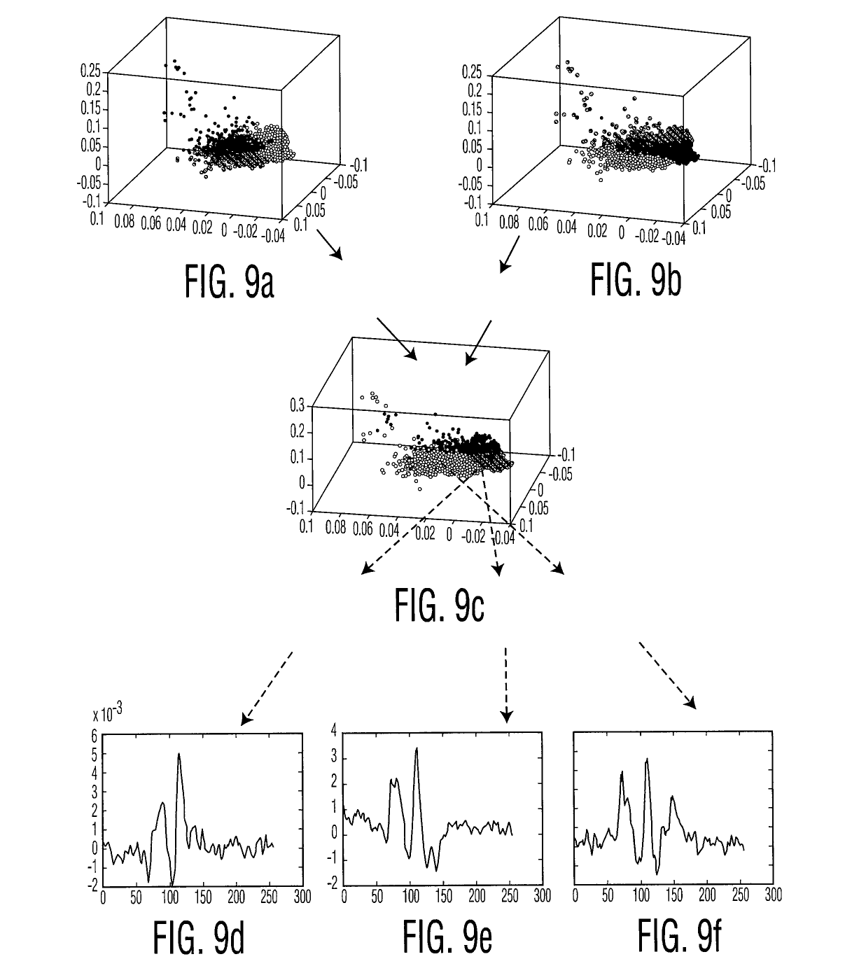

FIG. 9 (a)-(c) shows the clustering plots obtained by performing consensus clustering on the spectral data for identification of CaP and (d), (e) and (f) show the independent components (ICs) obtained by each cluster respectively. The results are shown using dots having three colors, blue (dark dots), red (medium dots) and green (light dots) Red cluster was identified as the cluster belonging to cancer. Note that the IC obtained from the red cluster highly resembles the representative cancer spectra with elevated choline, creatine peaks. Similarly, green cluster belongs to benign with the IC resembling a typical benign spectrum with reduced choline, creatine peaks.

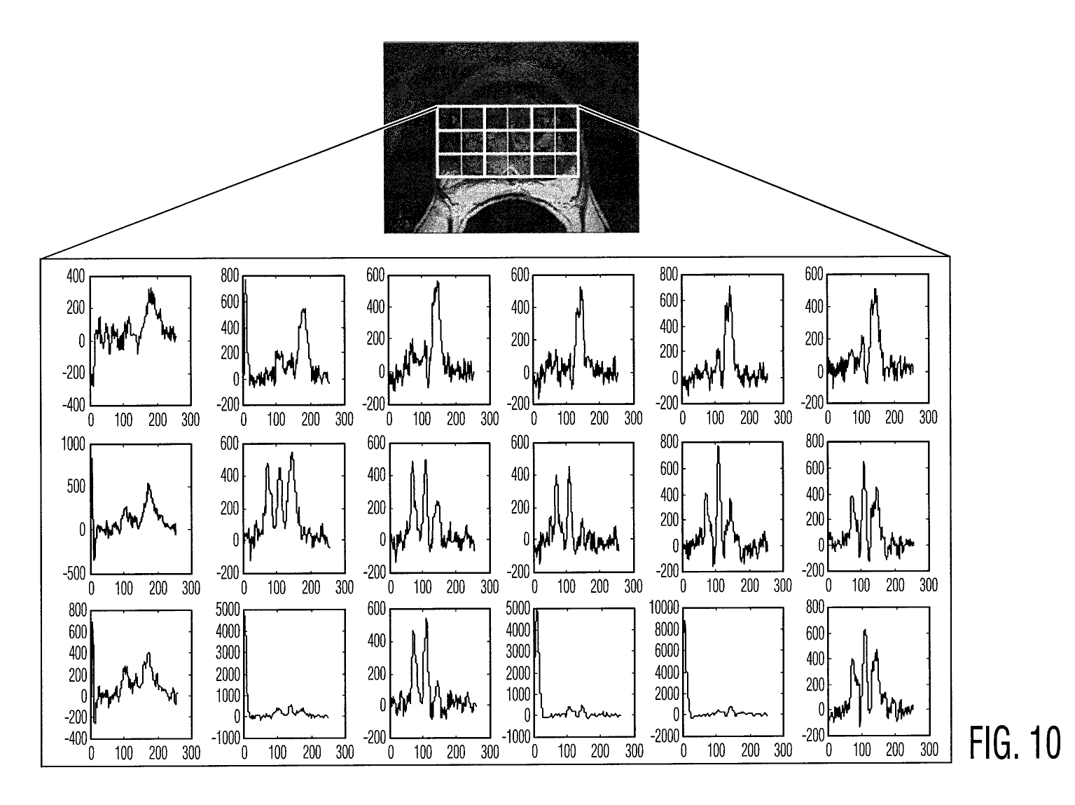

FIG. 10 shows the three clusters identified as cancer, benign and other classes plotted back on the spectral grid. Note the similarity between the spectra from the same cluster. Also note that in FIG. 9(d)-(f) the ICs obtained from each cluster provide fairly decent representation of the spectral cluster to which they belong.

Thus a novel qualitative method has been described which incorporates prior knowledge (information about cancer and benign spectra) to validate the results obtained by the example unsupervised scheme thereby improving the accuracy of cancer detection using our automated algorithms. The invention also provides a novel grading system for automatically identifying biologically significant prostate cancer for early diagnosis and treatment.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for classifying a possible cancer from a magnetic resonance spectrographic (MRS) dataset, the method comprising:
extracting at least one feature from the MRS dataset as being identified with the possible cancer;
embedding the extracted feature into a low dimensional space to form an embedded space;
clustering the embedded space into clusters representing a plurality of predetermined classes;
spectrally decomposing the clusters to identify substantially significant independent metabolic signatures; and
classifying the possible cancer as belong to one of at least two cancer classes based on the identified independent metabolic signatures.
